(19) United States
(12) Patent Application Publication
(10) Pub. No.: US 2018/0034837 A1
(43) Pub. Date: Feb. 1, 2018

(54) IDENTIFYING COMPROMISED COMPUTING DEVICES IN A NETWORK

(71) Applicant: SS8 Networks, Inc., Milpitas, CA (US)

(72) Inventors: Faizel Zulfikar Lakhani, Campbell, CA (US); Rajdeep Singh Wadhwa, San Jose, CA (US); Nagendra Swamy Honnalagere Shivanna, San Jose, CA (US)

(21) Appl. No.: 15/221,397

(22) Filed: Jul. 27, 2016

(51) Int. Cl. H04L 29/06

(52) U.S. Cl. CPC H04L 63/1425; H04L 63/1441

(57) ABSTRACT

Disclosed are systems, methods, and non-transitory computer-readable storage media for identifying compromised computing devices in a computer network. A threat detection engine can gather network data describing performance of a secured computer network. The secured computer network can include a set of computing devices. The threat detection server can apply a set of threat detection algorithms to the network data to yield threat detection data for the secured computer network. The threat detection engine can then calculate, based on the threat detection data, a threat value for at least a first computing device from the set of computing devices. The threat value can indicate an estimated likelihood that the first computing device has been compromised and/or the severity of the compromise. The threat detection server can then present a visual representation of the threat value for at least the first computing device from the set of computing devices.

### TECHNICAL FIELD

The present technology pertains to network security, and more specifically pertains to identifying compromised computing devices in a computer network.

### BACKGROUND

Computer networks are under constant attack from hackers and other online predators. A multi-billion dollar network security industry has been built around firewall technologies aimed at monitoring network traffic to identify and block malicious network traffic. This industry engages in a never-ending effort to prevent network attacks and intrusions. Even with this heavy investment in preventive technologies, network breaches will inevitably occur.

Determining whether a network has been breached and what computing devices have been compromised can be a tedious process. Network administrators are tasked with evaluating computing device in the network one by one to assess whether they have been compromised or pose a security risk. This can be both resource intensive and time consuming. Accordingly, improvements are needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for identifying compromised computing devices in a computer network. A threat detection engine can gather network data describing performance of a secured computer network. The secured computer network can include a set of computing devices. The threat detection server can apply a set of threat detection algorithms to the network data to yield threat detection data for the secured computer network. The threat detection engine can then calculate, based on the threat detection data, a threat value for at least a first computing device from the set of computing devices. The threat value can indicate an estimated likelihood that the first computing device has been compromised and/or the severity of the compromise. The threat detection server can then present a visual representation of the threat value for at least the first computing device from the set of computing devices.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary computing system for identifying compromised computing devices in a computer network;

FIG. 2 illustrates an example method of identifying compromised computing devices in a computer network;

FIG. 3 illustrates an example user interface presenting visual representations of threat values calculated for computing devices; and

FIGS. 4A and 4B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for identifying compromised computing devices in a computer network. A threat detection engine can gather network data describing performance of a secured computer network. The secured computer network can include a set of computing devices. The threat detection server can apply a set of threat detection algorithms to the network data to yield threat detection data for the secured computer network. The threat detection engine can then calculate, based on the threat detection data, a threat value for at least a first computing device from the set of computing devices. The threat value can indicate an estimated likelihood that the first computing device has been compromised and/or the severity of the compromise. The threat detection server can then present a visual representation of the threat value for at least the first computing device from the set of computing devices.

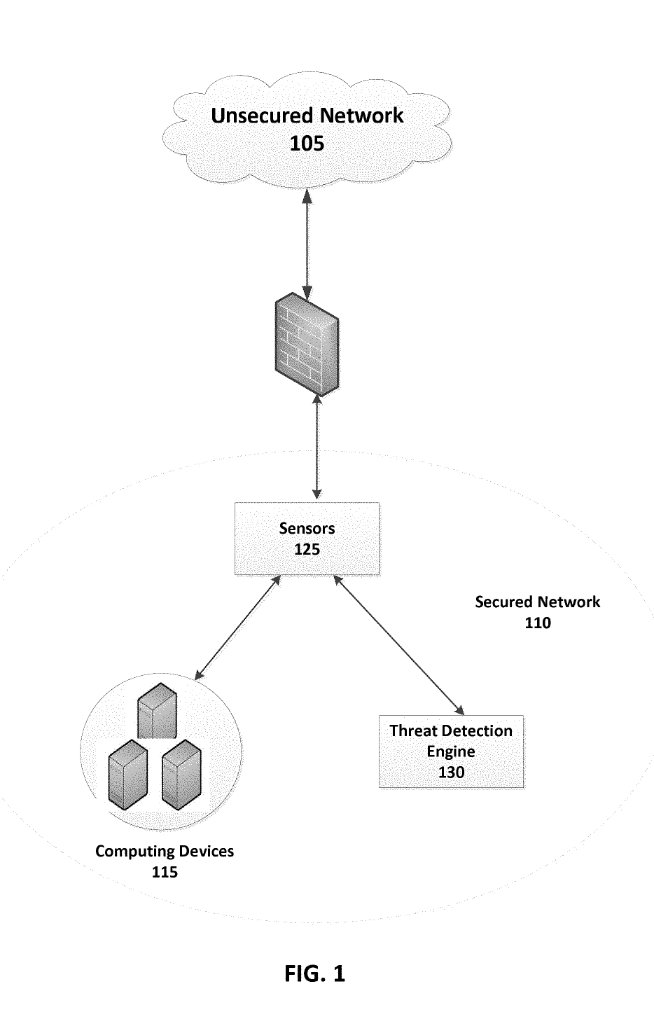

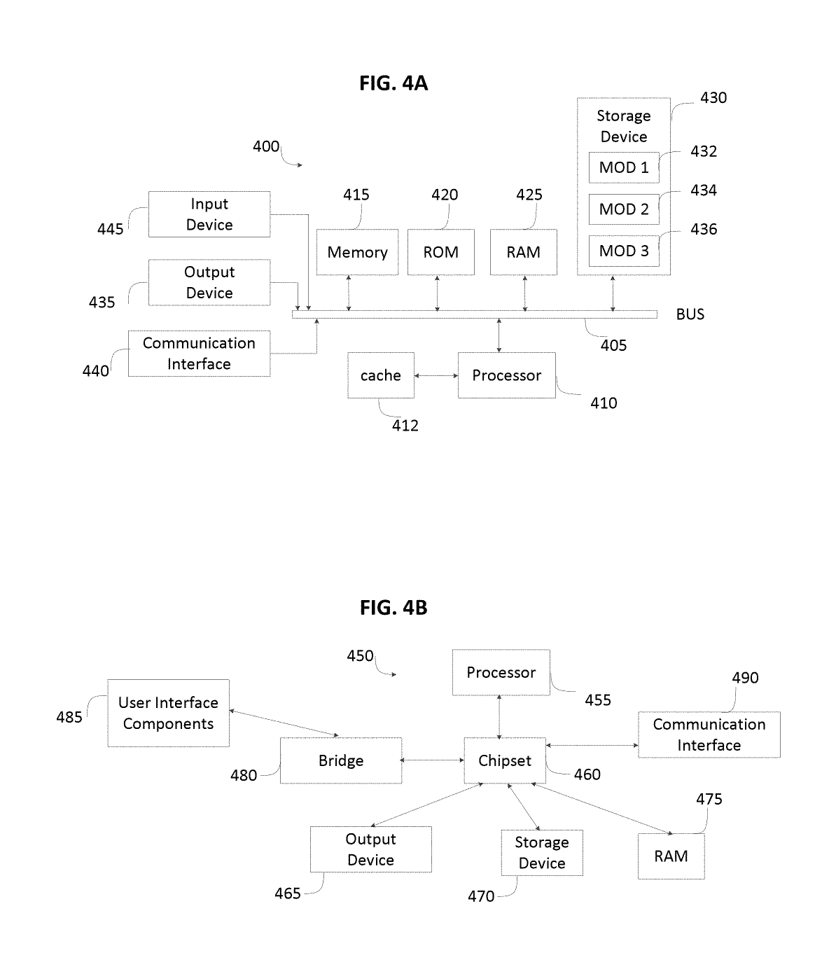

FIG. 1 illustrates an exemplary computing system for identifying compromised computing devices in a computer network. A compromised computing device can be a computing device that has been affected due to a malicious network attack. As shown, system 100 includes multiple computing devices in network communication. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 400 of FIGS. 4A and 4B.

System 100 includes unsecured network 105, such as the Internet, and secured network 110. Secured network 110 can include computing devices 115, sensors 125 and threat detection engine 130 sitting behind firewall 120.

Firewall 120 can include one or more commercially available network intrusion devices that allow for parsing raw packet data transmitted between unsecured network 105 and secured network 110. For example, raw packet data transmitted from unsecured network 105 to computing devices 115 in secured network 110 can be initially funneled through firewall 120.

Raw packet data can be inclusive of any data communications between computing devices 115 and other computing device not a part of a secured network 110. Raw packet data can be collectively representative of a network data flow, which may be received over the course of hours, days, months, or years. The parsed raw packet data in conjunction with the generation of metadata by sensors 125 (as further described herein) can be used to extract, collect, and generate network data that allows for the tracking of advanced and slowly developing attacks and remote access tools. This insight into network activity, including even non-malicious activity, may be reviewed and later studied by threat detection engine 130 (as further describe herein) to identify compromised computing devices 115 in secured network 110.

Sensors 125 can sit behind firewall 120 in secured network 110. Sensors 125 can provide seamless high-speed packet analysis and generate User Communication Application Records (UCARs) without otherwise interrupting day-to-day network services of secured network 110.

Sensors 125 can generate and provide metadata to threat detection engine 130. Sensors 125 may be positioned or otherwise configured at key locations within secured network 110, such as relative to critical document or information stores or with respect to particularly sensitive subsets of an otherwise protected network. Sensors 125 can be software, hardware, or a combination thereof, including but not limited to executable instructions stored in a non-transitory computer readable storage medium and otherwise executed by a processing device.

Sensors 125 can create metadata for communications data received by sensors 125. The created metadata can correlate to session-level and/or application-level extraction in order to generate events at scale. Sensors 125 can extract the metadata using deep packet inspection techniques. Metadata can include one or more of md5hash data, filenames, file-sizes, and subject information.

Threat detection engine 130 can receive data from sensors 125, as well as user and device identity data related to network interactions as well as threat intelligence from one or more threat feeds. Threat detection engine 130 can apply the user and device identity data and threat intelligence from the one or more threat feed to the generated metadata to identify a network threat. Threat detection engine 130 can monitor, store, and ingests immutable structured traffic that is representative of a fraction of the space otherwise required to store source data, for example 0.01%, or less. Threat detection engine 130 can allow for UCAR storage with real-time data enrichment and automatic enrichment between communications events and identity, device, and geographic destination. UCARs may be compressed at a ratio of 40:1 thereby allowing for months or years of retention and review.

In some instances, threat detection engine 130 may apply user and device identity data and/or threat intelligent from the one or more threat feeds against UCAR or other historical data (versus real time data). Historical data may also be considered in the context of real-time data. Based on the nature of a particular network threat and a collective history of network traffic flow over the course of time, analytics performed by threat detection engine 130 may allow for identification of compromised users, files, and network nodes. Such an identification may in turn allow for removal, rehabilitation, or further investigation.

The use of historical data may be of particular relevance in the context of a preexisting network vulnerability. Many network vulnerabilities may be related to a bug or flaw in coding that has long been present but unknown to a network administrator or device manufacturer. In such an instance, an otherwise secure enterprise (or believed to have been secured enterprise) may have long been the victim of the aforementioned vulnerability and prior to any threat intelligence having been provided with respect to the same. System 100 may use the historical information to analyze network behavior and potential exposure to intrusion or other compromising behavior once a threat feed is updated to provide notice of the vulnerability or that said vulnerability is other discovered in its own right.

Device identity data can include one or more of an Internet Protocol (IP) address, active directory userid, or other active directory userid. Device identity data can also include dynamic host configuration protocol (DHCP) macid, GeoIP information, or domain name server (DNS) data for an IP address.

Threat intelligence can be subscription based. These threat intelligence feeds alert subscribers about potential infections that have been found in one or more networks around the globe. Threat intelligence is generally representative of network activity that poses a threat to the security infrastructure of an enterprise. Threat intelligence 170 might include a definition of a network threat or threat signature. Threat intelligence might otherwise include an indicator of compromise. Such indicators are inclusive of a list of md5s or shals of malicious binaries, a list of IP addresses that are known to spread malicious files, a list of websites that are hosting malware, or a list of behaviors that are indicative of data exfiltration. Indicators might also include includes a list of email addresses that “phish,” a list of email subject lines that are used to “phish,” a list of IP addresses of mail servers that are known to spread “phishing” email communications, or list of IP addresses of mail server that are known to spread mal ware. Indicators of compromise are also inclusive of lists of potential vulnerabilities or points of exploitation. These lists might correspond to an operating system. These lists might also correspond to a specific application.

Threat detection engine 130 can use received data, such as network data (i.e., parsed packet data and metadata) received from firewall 120 and sensors 125 to determine whether as security breach of secured network 110 has taken place as well as identify computing devices 115 in secured network 110 that may have been compromised by an outside attack. To accomplish this threat detection engine 130 can apply a set of threat detection algorithms to the network data to generate threat detection data indicating threat activity associated with each of computing devices 115 that suggest that a particular computing device 115 may have been compromised. Threat detection engine 130 can then use the threat detection data to calculate a threat value for each of the individual computing devices 115 that indicates an estimated likelihood that a computing device has been compromised. A network administrator can use the threat values to determine whether a security breach of secured network 110 has occurred and to focus their efforts in identifying and eradicating security breaches within secured network 110.

A threat detection algorithm can be any type of algorithm designed to detect threat activity that may indicate that a computing device 115 has been compromised. For example, a threat detection algorithm can analyze the network data to detect mechanisms on computing devices 115 used to find open ports in secured network 110 or mechanisms attempting to reach Command and Control (C&C) servers outside of secured network 110. As another example, a threat detection algorithm can analyze the network data to identify port anomalies, such as non-standard protocols being used over standard ports. Tunneling over well know ports is a common evasion technique to bypass a firewall.

In some embodiments, a threat detection algorithm can detect executable file transfers, file extension mismatches or massive data exfiltration. For example, the threat detection algorithms can detect file transfers over any application, file extension mismatches between assigned file names and an actual file type obtained through content analysis or detecting one way file transfers that exceed a threshold file transfer size.

In some embodiments, the threat detection algorithms can identify host scanning, such as mechanisms used to scan secured network 110 for Internet Protocol (IP) addresses of computing devices 115 using File Transfer Protocol (FTP), Structured Query Language (SQL) or Secure Shell (SSH).

In some embodiments, the threat detection algorithms can detect Uniform Resource Identifier (URI) brute force attacks on computing devices 115 used as web servers or password brute force attacks on computing devices 115 that have SSH connectivity.

These are just a few examples of threat detection algorithms and are not meant to be limiting. A threat detection algorithm can be any type of algorithm used to analyze network data to identify actions, anomalies or any other indicator that a computing device is under attack or has been compromised. For example, threat detection algorithms can identify application anomalies, clicked Uniform Resource Locators (URLs) within an e-mail, connections to untrusted/shady top level domains, “side-jacking”, exploit kits, abnormal user agent fields, fast flux Domain Name System (DNS), Hyper-Text Transfer Protocol (HTTP) meterpreter sessions, File Transfer Protocol (FTP) over HTTP, encrypted reverse Transmission Control Protocol (TCP), C&C channels, botnets, etc.

Threat detection engine 130 can calculate the threat value for a computing device 115 in any number of ways and taking into account any number of factors. For example, threat detection engine 130 can calculate the threat value for a computing device 115 based on the total number of individual instances of threat activity associated with the computing device 115, the number of different types of threat activity associate with the computing device 115, the frequency of the threat activity, etc. Further, the different types of threat activity can be weighted according to how strongly they indicate that a computing device 115 has been compromised. Accordingly, an instance of a highly weighted threat activity can cause a greater increase in the threat value of a computing device 115 than an instance of a lower weighted threat activity.

Threat detection engine 130 can present a visual representation of the threat values calculated for computing devices 115. The visual representation can identify a computing device 115 (e.g, Machine Access Code (MAC) or other identifier) as well as include an indicator of the threat value for the computing device. This can include presenting a numeric threat value for the computing device 115 and/or a threat level indicating the likelihood that the computing device 115 has been compromised (e.g, high, moderate, low, etc.). In some embodiments, the indicator of the threat value can include a color scheme to represent the perceived threat level, such as red to represent a high threat, yellow to represent a moderate threat and green to represent a low threat. An administrator can use the visual representation of the threat values to identify computing devices 115 that are likely to have been compromised and manage the task of eradicating any such breaches.

In some embodiments, threat detection engine 130 can be configured to provide additional threat data regarding a computing device 115. For example, the visual representation of the threat value for a computing device 115 can be configured to be selectable by a user to request a detailed view of the threat data associated with the computing device 115. Upon receiving an input indicating that a user has selected the visual representation of the threat value, threat detection engine 130 can present a visual representation of threat detection data associated with the computing device 115. For example, the visual representation of the threat detection data can include a visual representation of a total number of individual instances of threat activity associated with the computing device 115, a visual representation of types of threat activity associated with the computing device 115, etc. Further, in some embodiments, the threat detection data can also include suggested remedial actions based on the threat detection data associated with the first computing device. A system administrator can use this data as well as suggested remedial actions to diagnose and/or correct a compromised computing device 115.

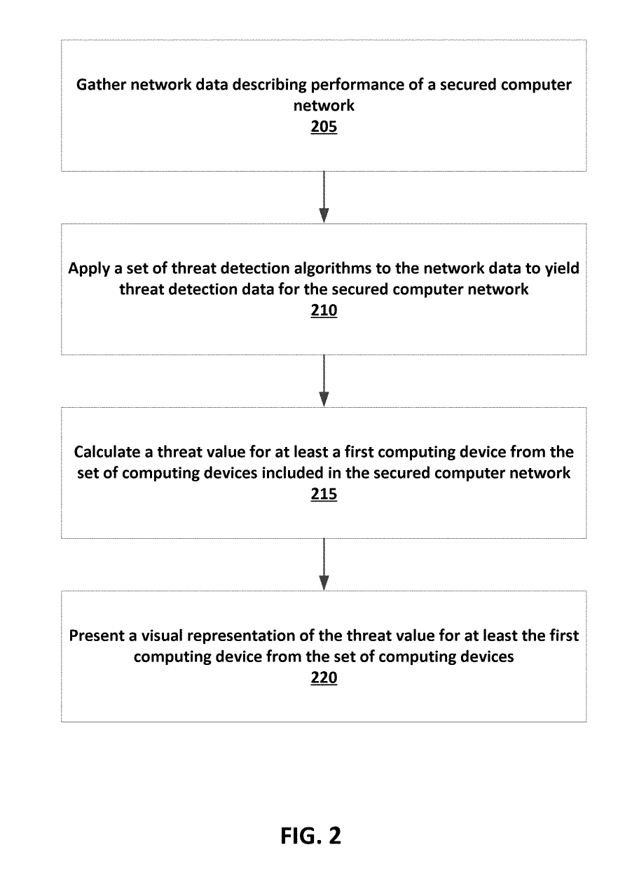

FIG. 2 illustrates an example method of identifying compromised computing devices in a computer network. It should be understood that there can be additional, fewer, or alternative steps performed in similar or alternative orders, or in parallel, within the scope of the various embodiments unless otherwise stated.

At step 205 a threat detection engine can gather network data describing performance of a secured computer network. The secured computer network can include a set of computing devices sitting behind a firewall and one or more sensors. The network data can include parsed packet data and metadata generated by the firewall and the sensors.

At step 210 the threat detection engine can apply a set of threat detection algorithms to the network data to yield threat detection data for the secured computer network. A threat detection algorithm can be any type of algorithm designed to detect threat activity that may indicate that a computing device has been compromised.

At step 215 the threat detection engine can calculate a threat value for at least a first computing device from the set of computing devices included in the secured computer network. For example, the threat detection engine can calculate a threat value for one, some or all computing devices in the secured network. The threat value can indicate an estimated likelihood that the first computing device has been compromised and/or the severity of the compromise.

At step 220 the threat detection engine can present a visual representation of the threat value for at least the first computing device from the set of computing devices. The visual representation can identify the first computing device, (e.g, Machine Access Code (MAC) or other identifier) as well as include an indicator of the threat value for the first computing device (e.g., numeric threat value and/or a threat level).

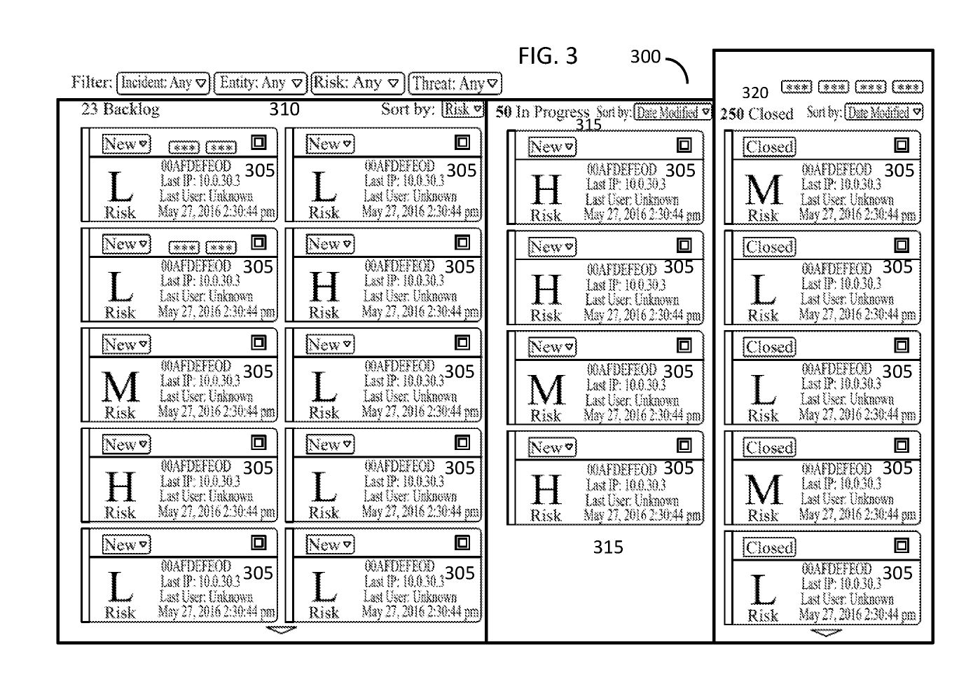

FIG. 3 illustrates an example user interface presenting visual representations of threat values calculated for computing devices. As shown, user interface 300 includes multiple cards 305, each providing a visual representation of a computing device and the threat value calculated for the computing device. For example, cards 305 can include a letter indicating the threat level of the associated computing device, such as L for low risk, M for medium risk and H for high risk. Further, cards 305 can be color coded to indicate their associated threat level. For example, cards 305 can be colored green to indicate a low risk, yellow to indicate a medium risk and red to indicate a high risk.

Cards 305 can be selectable to allow a user to view detailed networking data associated with a computing device. For example, in response to selecting one of card 305, the user can be presented with a visual representation of a total number of individual instances of threat activity associated with the computing device, a visual representation of types of threat activity associated with the computing device, etc.

Further user interface 300 can allow a user to manage cards 304. As shown, user interface 300 include backlog section 310, in progress section 315 and closed section 320. A user can move cards 305 to a corresponding section to indicate the cards status. This can allow an administrator to easily manage and track the status of their work.

FIG. 4A, and FIG. 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
gathering network data describing performance of a secured computer network, the secured computer network including a set of computing devices;
applying a set of threat detection algorithms to the network data to yield threat detection data for the secured computer network;
for at least a first computing device from the set of computing devices included in the secured computer network, calculating, based on the threat detection data, a threat value indicating an estimated likelihood that the first computing device has been compromised; and
presenting a visual representation of the threat value for at least the first computing device from the set of computing devices.

2. The method of claim 1, further comprising:
receiving an input indicating that a user has selected the visual representation of the threat value for the first computing device; and
in response to receiving the input, presenting a visual representation of threat detection data associated with the first computing device.

3. The method of claim 2, wherein the visual representation of the threat detection data includes a visual representation of a total number of individual instances of threat activity associated with the first computing device.

4. The method of claim 2, wherein the visual representation of the threat detection data includes a visual representation of types of threat activity associated with the first computing device.

5. The method of claim 2, wherein the visual representation of the threat detection data includes suggested remedial actions based on the threat detection data associated with the first computing device.

6. The method of claim 1, wherein the threat value for the first computing device is calculated based on at least one of a total number of individual instances of threat activity associated with the first computing device, a number of different types of threat activity associate with the first computing device or a frequency at which threat activity associated with the first computing device occurred.

7. The method of claim 1, wherein the set of threat detection algorithms includes an algorithm to detect a mechanism used to reach out to command and control servers outside of the private computer network.

8. A system comprising:
one or more computer processors; and
a memory storing instructions that, when executed by the one or more computer processors, cause the system to:
gather network data describing performance of a private computer network, the private computer network including a set of computing devices;
apply a set of threat detection algorithms to the network data to yield threat detection data for the private computer network;
for at least a first computing device from the set of computing devices included in the private computer network, calculate, based on the threat detection data, a threat value indicating an estimated likelihood that the first computing device has been compromised; and
present a visual representation of the threat value for at least the first computing device from the set of computing devices.

9. The system of claim 8, wherein the instructions further cause the system to:
receive an input indicating that a user has selected the visual representation of the threat value for the first computing device; and
in response to receiving the input, present a visual representation of threat detection data associated with the first computing device.

10. The system of claim 9, wherein the visual representation of the threat detection data includes a visual representation of a total number of individual instances of threat activity associated with the first computing device.

11. The system of claim 9, wherein the visual representation of the threat detection data includes a visual representation of types of threat activity associated with the first computing device.

12. The system of claim 9, wherein the visual representation of the threat detection data includes suggested remedial actions based on the threat detection data associated with the first computing device.

13. The system of claim 8, wherein the threat value for the first computing device is calculated based on at least one of a total number of individual instances of threat activity associated with the first computing device, a number of different types of threat activity associate with the first computing device or a frequency at which threat activity associated with the first computing device occurred.

14. The system of claim 8, wherein the set of threat detection algorithms includes an algorithm to detect a non-standard protocol being used over a standard port of the private computer network.

15. A non-transitory computer-readable medium storing instructions that, when executed by a computer server, cause the computer server to:
gather network data describing performance of a private computer network, the private computer network including a set of computing devices;
apply a set of threat detection algorithms to the network data to yield threat detection data for the private computer network;
for at least a first computing device from the set of computing devices included in the private computer network, calculate, based on the threat detection data, a threat value indicating an estimated likelihood that the first computing device has been compromised; and
present a visual representation of the threat value for at least the first computing device from the set of computing devices.

16. The non-transitory computer-readable medium of claim 15, wherein the instructions further cause the computer server to:
receive an input indicating that a user has selected the visual representation of the threat value for the first computing device; and
in response to receiving the input, present a visual representation of threat detection data associated with the first computing device.

17. The non-transitory computer-readable medium of claim 16, wherein the visual representation of the threat detection data includes a visual representation of a total number of individual instances of threat activity associated with the first computing device.

18. The non-transitory computer-readable medium of claim 16, wherein the visual representation of the threat detection data includes a visual representation of types of threat activity associated with the first computing device.

19. The non-transitory computer-readable medium of claim 16, wherein the visual representation of the threat detection data includes suggested remedial actions based on the threat detection data associated with the first computing device.

20. The non-transitory computer-readable medium of claim 15, wherein the threat value for the first computing device is calculated based on at least one of a total number of individual instances of threat activity associated with the first computing device, a number of different types of threat activity associate with the first computing device or a frequency at which threat activity associated with the first computing device occurred.
